(19) United States
(12) Patent Application Publication
(10) Pub. No.: US 2016/0178058 A1
(43) Pub. Date: Jun. 23, 2016

(54) PERMANENTLY PLASTIC PUTTY GASKET FOR FIRE-PROTECTION APPLICATIONS

(71) Applicant: Hilti Aktiengesellschaft, Schaan (LI)

(72) Inventor: Herbert MÜNZENBERGER, Wiesbaden (DE)

(21) Appl. No.: 14/575,726

(22) Filed: Dec. 18, 2014

(51) Int. Cl. F16J 15/06; F16L 5/10; H02G 3/22; F16J 15/10

(52) U.S. Cl. CPC F16J 15/065; F16J 15/102; F16L 5/10; H02G 3/22

(57) ABSTRACT

A gasket for sealing a gap between an external surface of a cylindrical structure and an inner surface of an opening is provided, comprising a ring shaped disc of permanent plastic putty comprising a matrix composition and containing at least one fire-protection additive, wherein the ring shaped disc is a C-shaped ring having a first end and a second end and a notch between the first end and the second end, wherein the ends seal against each other when the gap is sealed.

### BACKGROUND OF THE INVENTION

In construction, pipes and cables often run through masonry openings in walls and floors. Proper sealing of the masonry openings is very important for thermal insulation and tier preventing spread of fire from one area to another.

Thus, there is a continual need for materials that are easy to install and effective in thermal insulation and fire protection, for sealing masonry openings.

### BRIEF SUMMARY OF THE INVENTION

The invention provides a gasket for sealing a gap between an external surface of a cylindrical structure and an inner surface of an opening. In an embodiment, the gasket comprises a ring shaped disc of permanent plastic putty comprising a matrix composition and containing at least one fire-protection additive. Preferably, the ring shaped disc comprises a C-shaped ring having a first end and a second end and a notch between the first end and the second end, and the ends seal against each other when the gap is sealed.

### BRIEF DESCRIPTION OF THE SEVERAL VIEWS OF THE DRAWING(S)

FIG. 1 illustrates a top view of a gasket according to an embodiment of the invention.

FIG. 2 illustrates a side view of a gasket according to an embodiment of the invention, in use, sealing against a cylindrical structure.

FIG. 3 illustrates a top view of a gasket according to an embodiment, in use, sealing a gap between a masonry opening, and a cylindrical cable.

### DETAILED DESCRIPTION OF THE INVENTION

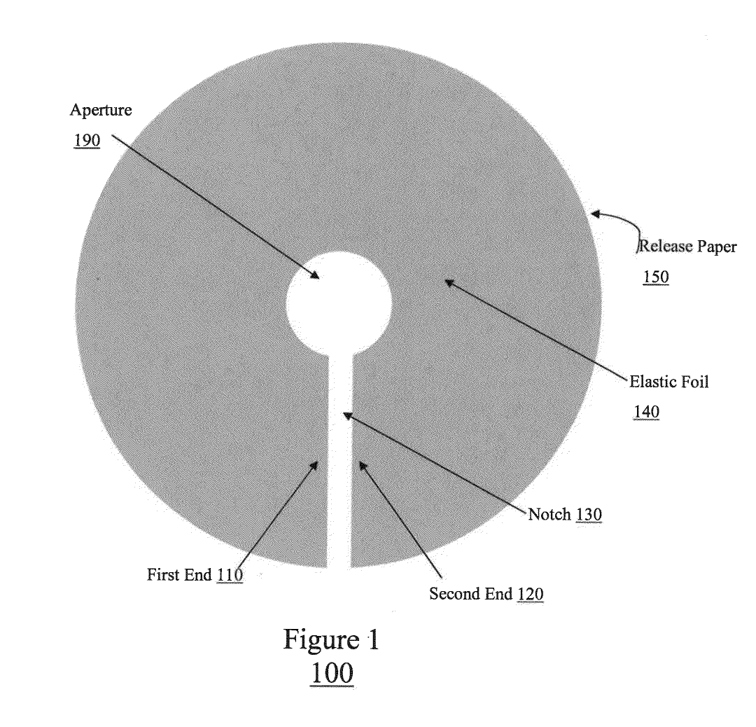

According to an embodiment as illustrated in FIG. 1, a gasket 100, for sealing a gap between an external surface of a cylindrical structure and an inner surface of an opening, comprises a ring shaped disc of permanent plastic putty comprising a matrix composition and containing at least one fire-protection additive. The illustrated ring shaped disc is a C-shaped ring having a first end 110 and a second end 120, an aperture 190, and a notch 130 between the first end and the second end, wherein the ends 110 and 120 seal against each other when the gap is sealed.

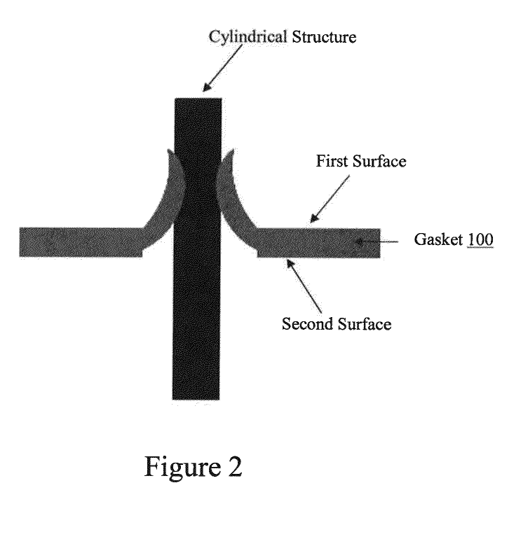

As illustrated in FIG. 2, the gasket 100, which is preferably a fire protective sealing disc, has first and second surfaces (the front and back disc surfaces), wherein a cylindrical structure is sealed in the aperture when the gap is sealed.

In the embodiment illustrated in FIG. 1, an elastic foil 140 is provided on the first surface of the fire protective sealing disc of the gasket 100, facing away from the opening (e.g., a masonry opening) to be sealed. The elastic foil 140 may provide, on one side of the foil, a surface for the sealing material of the gasket 100 to adhere to, and on the opposite side, a non-sticky surface for a user to hold the gasket 100. A user may press on the elastic foil 140 to reform the sealing material of the gasket 100 (e.g., such that the ends seal against each other and the gasket seals the gap) in a masonry opening. Thus, a user may handle the gasket 100 via the elastic foil 140 to quickly and easily install the gasket 100 to seal a masonry opening, without having the sealing material of the gasket 100 stick to the user's hands and equipment.

A release paper 150 may be provided on the second surface of the fire protective sealing disc, facing toward the masonry opening to be sealed. The release paper 150 may provide, on one side of the release paper, a surface for the sealing material of the gasket 100 to adhere to, and on the opposite side a non-sticky surface to for a user to hold the gasket 100. During use, the user may pull off the release paper 150 to expose the second surface of the fire protective sealing disc. Then, the user may press the second surface of the fire protective sealing disc into a masonry opening to seal it.

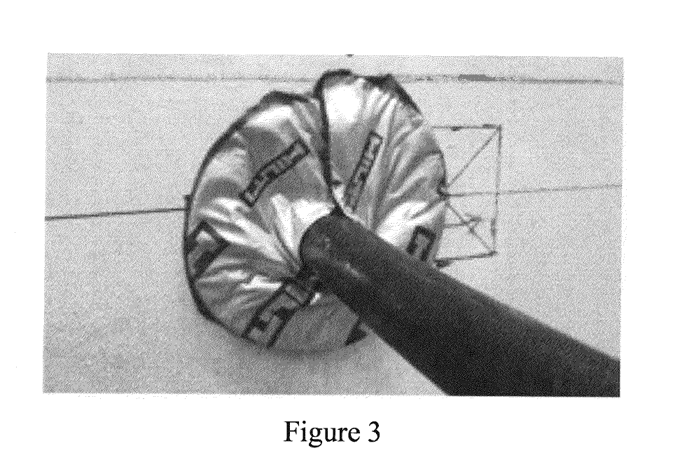

FIG. 3 illustrates sealing of a gap between the external surface of a cylindrical structure (for example, a wire, a cable, a cable bundle, and/or a pipe cable) and the inner wall of an opening (for example, a masonry opening such as a drywall opening), using an embodiment of the gasket 100. Using the notch and aperture, the gasket 100 is fit around the cable, and the first end 110 and the second end 120 of the gasket 100 are sealed against each other, and the gasket 100 is pressed over the gap between the cylindrical structure and the inner wall of the opening to form the seal.

A variety of cylindrical structures can be used, and a variety of gaps or openings can be sealed, as would be recognized by one of skill in the art. For example, the gasket 100 may be used for sealing or dividing off openings, cable and/or pipe bushings in walls, floors and/or ceilings, joints between ceiling parts and wall parts, between masonry openings and construction parts that are to be installed, such as window and door frames, between ceilings and walls and between exterior walls and curtaining facades of buildings against fire and smoke for the purpose of thermal insulation and/or fire protection.

In a preferred embodiment of the gasket 100, the fire protective additive forms an ash crust when exposed to fire.

The following description further illustrates embodiments of the invention but, of course, should not be construed as in any way limiting its scope.

In an embodiment of the gasket 100, the matrix composition includes organic polymers, including a mixture of an aqueous polymer dispersion (A) and a low-molecular weight, permanently plastic, liquid polymer (B). Preferably, the matrix composition includes, in a ratio by weight of (A) to (B) of about 6:1 to about 1:2.5 and more preferably, of about 4:3 to about 3:4.

The inventive gasket comprises a putty, which can also be referred to as a plasticine. Putties generally comprise liquid butyl rubber, plasticizers (paraffin oil, phthalates, adipates, etc.) and fillers, with a filler content of up to 80 percent. The inventive gasket can have any suitable thickness. Typically, the thickness is in the range of from at least about 1 mm to about 6 mm, though thicknesses can be below or above that range. In some embodiments, the thickness is in the range of from about 2 mm to about 3 mm.

By including a mixture of an aqueous polymer dispersion and a low molecular weight, permanently plastic, liquid polymer in putty (e.g., Plasticine) it has surprising turned out that, with the help of such a matrix composition, that has a low viscosity, physically intumescing, fire-protection additives, such as expanding graphite and intumescing vermiculite, that are delicate to shear, can also be incorporated into the matrix composition without loss of activity and without destruction of the particles with formation of corresponding degradation products. The permanently plastic putty can be used directly as a sealing disc. illustrative putties, matrix compositions, and additives, are described in, for example, U.S. Patent Application Publication 2005/0032934.

According to an embodiment, the inventive putty in the aqueous polymer dispersion (A) contains at least one representative of the group comprising polyurethanes, polyvinyl acetates, polyvinyl ethers, polyvinyl propionates, polystyrenes, natural or synthetic rubbers, poly((meth)acrylates) and homopolymers and copolymers based on (meth)acrylates, acrylonitrile, vinyl esters, vinyl ethers, vinyl, chloride and/or styrene, preferably, poly(alkyl methacrylates), poly(alkyl acrylates), poly(aryl methacrylates), poly(aryl acrylates) and/or copolymers thereof with n-butyl acrylate and/or styrene.

Preferably, for the preparation of the matrix composition, the aqueous polymer dispersion (A) has a water content of about 5 to about 60 percent by weight, and preferably of about 20 to about 40 percent by weight, which, in combination with the liquid polymer (B), makes it possible to introduce also delicate, fire-protection additives into the putty.

The aqueous polymer dispersion (A) preferably is contained in the matrix composition in such an amount, that the proportion of water in the finished putty (Plasticine) is about 2 to about 30 percent by weight, and preferably, about 5 to about 15 percent by weight, depending on the degree of drying.

According to an embodiment, the putty contains, as liquid polymer (B), at least one representative of the group comprising polyurethanes, polyvinyl acetates, polyvinyl ethers, polyvinyl propionates, polystyrenes, natural or synthetic rubbers, poly((meth)acrylates) and homopolymers and copolymers based on (meth)acrylates, acrylonitrile, vinyl esters, vinyl ethers, vinyl chloride and/or styrene, preferably poly(alkyl methacrylate), poly(alkyl acrylate), poly(aryl methacrylate), poly(aryl acrylate) and/or copolymers thereof with n-butyl acrylate and/or styrene.

The low molecular weight, permanently plastic, liquid polymer (B) preferably has a molecular weight, determined by the K value according to DIN ISO 1628-1, of about 100,000 to about 8,000,000 and more preferably, of about 250,000 to about 5,000,000.

Preferably, the low molecular weight, permanently plastic liquid polymer (B), as a 50 percent solution in ethyl acetate, has a viscosity, determined according to DEN ISO 3219 at 23 degrees centigrade, of about 40 to about 350 mPa.s and more preferably of about 50 to about 200 mPa.s.

Preferably, as fire-protection additives (C), the putty contains one or more additives, selected from one or more of the following: having a ceramizing effect (C1), an ablative effect (C2), an intumescing effect (C3) and/or a flame inhibiting effect (C4).

Fire-protection additives with ceramizing activity (C1) are additives which, in the event of a fire, form a very solid ash from the putty without any change in volume. They may be glass-forming additives such as powdered glass, sintered glass, ammonium polyphosphate or borates; additives, which, in actual fact, do not have a ceramizing effect such as kaolin, clay and bentonite, as well as certain polymers with a high aromatic content, which tend to carbonize and, by so doing, support the sintering of the fillers. Preferably, the percentage of inorganic fillers, which sinter together with the additives, is high.

According to an embodiment, any one or more of the following: powdered glass, sintered glass, fiberglass, zinc borates, ammonium polyphosphates, kaolin, clay, bentonite and mixtures of these additives are used as additive (C1) with a ceramizing activity.

According to an embodiment, any one or more of the following: aluminum hydroxide, magnesium hydroxide, boehmite (AlOOH), zinc borate, calcium sulfate, colemanite, ulexite, boracite and mixtures thereof are used as additive with an ablative activity (C2), which are energy-consuming in the event of a fire, because they split off water or carbon dioxide and, by these means, reduce the burning rate of the material.

As intumescing, fire-protection additives (C3), the putty preferably contains physically intumescing fire-protection additives, particularly thermally expandable graphites, vermiculites and perlites, especially expanding graphite, which optionally has an onset temperature, which has been modified chemically by introducing certain intercalation compounds. The onset temperature is the temperature, at which the expansion process commences. These physically intumescing fire-protection additives have the advantage over chemically intumescing fire-protection additives, that they make possible a significantly higher expansion pressure and higher expansion volume so that, by bringing these fire-protection additives into the putty, the requirements, which fire-protection compositions for plastic pipes, plastic-insulated cables and cable bundles and steel pipes with organic insulation must meet, can be fulfilled.

Aside from these preferred, physically intumescing fire-protection additives, the putty may also comprise chemically intumescing mixtures, containing, for example, one or more of any of the following: an acid forming compound, for example, ammonium polyphosphate; a gas forming compound, for example, melamine or derivatives thereof, especially melamine phosphate and melamine cyanurate, ethylenediamine phosphate, guanidine, hydrazine and tris-2-hydroxyethylene cyanurate, and at least one source of carbon (e.g., for forming an ash crust), preferably pentaerythritol. In some embodiments, the putty comprises an acid forming compound and a gas forming compound, optionally, further comprising a source of carbon. In some embodiments, the source of carbon provides the matrix for the matrix composition, such that a separate component for the matrix is not necessary.

As flame-inhibiting additives (C4), the putty may contain at least one representative of the group comprising red phosphorus, phosphorus compounds, especially triethyl phosphate, triphenyl phosphate, diphenylcresyl phosphate, diphenyl-2-ethylhexyl phosphate, tricresyl phosphate, tris(2-ethylhexyl) phosphate, halogenated phosphate esters, especially trichloroethyl phosphate, tris(2-chloroisopropyl) phosphate, tris(tribromophenyl) phosphate, trisbromoneopentyl phosphate and tris(2-chloroethyl) phosphate, cycloaliphatic bromine compounds, especially hexabromocyclododecane, aromatic bromine compounds, especially tris(tribromophenyl)-triazine, poly(pentabromobenzyl acrylate), octabromodiphenyl oxide, decabromodiphenyl oxide, brominated trimethylphenylindane and metal hydroxides, especially aluminum hydroxide or magnesium hydroxide, zinc borate, ammonium polyphosphate and antimony trioxide or pentoxide.

According to an embodiment, the putty may contain water (D), stabilizers (E), pigments (F) and/or fillers (G) as conventional auxiliary materials.

As stabilizers (E), preferably fungicides, biocides, dispersing agents, anti-aging agents, Theological additives, lubricants, anti-freezing agents or mixtures thereof may be used.

As pigments (F), the putty may contain red iron oxide, brown iron oxide, yellow iron oxide, titanium dioxide, carbon black, zinc oxide, chromium oxides or mixtures thereof.

According to an embodiment, the putty contains, as a filler (G), an inorganic filler, selected from the group comprising the metal oxides, borates, carbonates, preferably chalk, silicates, kaolin, barium sulfate, talcum, powdered glass, iron oxide, titanium dioxide, silica, inorganic foams, preferably foamed expanded clay, foamed perlite and foamed vermiculite, and/or small hollow spheres of a silicate material or glass, reinforcing fillers, especially fiberglass, mineral fibers, ceramic fibers, wollastonite, highly dispersed silica and mixtures thereof.

According to an embodiment, the above-defined putty may include: about 10 to about 30 percent by weight and preferably about 15 to about 25 percent by weight of the aqueous polymer dispersion (A), about 5 to about 25 percent by weight and preferably about 10 to about 20 percent by weight of the low molecular weight, permanently plastic, liquid polymer (B), about 2 to about 50 percent by weight, and preferably about 5 to about 35 percent by weight of the fire-protection additive (C), about 2 to about 30 percent by weight and preferably about 5 to about 15 percent by weight of water (D), about 0.1 to about 2.0 percent by weight and preferably about 0.5 to about 1.5 percent by weight of stabilizers (E), about 0.1 to about 2.0 percent by weight and preferably about 0.5 to about 1.5 percent by weight of pigment (F) and/or about 15 to about 60 percent by weight and preferably about 16 to about 20 percent by weight of fillers (G), in each case relative to the weight of the putty and with the proviso that the amount of all the components does not exceed 100 percent.

According to another embodiment, the putty may include about 2 to about 20 percent by weight and preferably about 5 to about 12 percent by weight of the fire-protection additive (C1), about 2 to about 36 percent by weight and preferably about 5 to about 35 percent by weight of the fire-protection additive (C2), about 5 to about 35 percent by weight and preferably about 10 to about 30 percent by weight of the fire-protection additive (C3), and/or about 1 to about 20 percent by weight and preferably about 0.5 to about 5 percent by weight of the fire-protection additive (C4), in each case relative to the weight of the putty and with the proviso that the total amount of the fire-protection additive (C) does not exceed about 60 percent by weight of the putty.

The putty is permanently plastic, which means that, if it is used as intended, it is not cured even after a prolonged period and, instead, can be detached readily once again from the site of application and used once more, without loss of the fire-protection effect of the physically intumescing additives present in the putty. In sonic embodiments, it has a viscosity, determined by the needle penetration test according to DIN 515792, corresponding to a depth of penetration of the needle (at a total weight of 12.5 g, a penetration time of 5 seconds at 20 degrees centigrade) of about 3 to about 40 mm, and preferably of about 3 to about 20 mm, the higher depths of penetration occurring at a higher water content of the putty.

Table 1 below lists possible component mixture of 3 base compounds, each of which may be mixed and homogenized with 3 variant additive compounds, for different effects and purposes.

TABLE 1

| | Example- | | Amount |
|---|---|---|---|
| | chemical | Active | (% of total |
| Compound | components | Components | weight) |
| Base compound 1 | Acronal V275 | Acrylic Latex | 8-20% |
| Plastic Acrylic | Acronal A4 | Liquid Acrylic | 10-25% |
| | | Polymer | |
| | | Water | 0-8% |
| | dispersant | Stabilizing agent | 0.2-3% |
| | fungicide | | |
| | iron oxide, TiO₂, | Pigment | 0-4% |
| | carbon black | | |
| | clay, talcum, | Organic Filler | 15-50% |
| | chalk | | |
| Base compound 2 | | Butylrubber/PIB | 3-10% |
| Plastic Butyl | Indopol H 100 | Liquid Polybutene | 5-10% |
| | Oppanol | polymer | |
| | Gravex | Mineral oil | 0-8% |
| | Torilis | Adhesive resin | 0.2-3% |
| | Escorez | | |
| | iron oxide, TiO₂, | Pigment | 0-4% |
| | carbon black | | |
| | Irganox | Stabilizing agent | 0.2-2% |
| | clay, talcum, | Organic Filler | 40-50% |
| | chalk | | |
| Base compound 3 | | Butylrubber | 0-2% |
| Oil Based | Indopol H 100 | Liquid Polybutene | 0-5% |
| | Oppanol | polymer | |
| | Gravex | Mineral oil | 15-30% |
| | iron oxide, TiO₂, | Pigment | 0-4% |
| | carbon black | | |
| | clay, talcum, | Organic Filler | 40-50% |
| | chalk | | |
| Additive Compound | zinc borate, | Ceramizing | 6-15% |
| Variant 1 | ammonium | additives | |
| Sealing Compound | polyphosphate | | |
| with rigid ash crust | glass fiber | Ash crust stabilizer | 0.5-4% |
| | dipentaeryhrit | Synergist | 0.5-4% |
| Additive Compound | zinc borate | Synergist | 0-10% |
| Variant 2 | aluminum | Ablative additive | 10-35% |
| Fire-retardant | hydroxide | | |
| Additive Compound | exfoil. Graphite | Heat expand. | 1-8% |
| Variant 3 | | Additive | |
| Intumescent | ammonium | Ceramizing | 6-15% |
| Compound | polyphosphate | additives | |
| | glass fiber | Ash crust stabilizer | 0.5-4% |
| | dipentaeryhrit | Synergist | 0.5-4% |

In an embodiment, a method for manufacturing the gasket is provided. The method may include:
a) forming a homogeneous mixture of the aqueous polymer dispersion and water;
b) adjusting a pH of the homogeneous mixture to a range of between 8 and 9;
c) mixing the low molecular weight, permanently plastic, liquid polymer into the homogeneous mixture; and
d) incorporating at least one of an additive with a ceramizing effect, an additive with an ablative effect, an additive with a flame-inhibiting effect, and an additive with an intumescing effect, and homogenizing the additive with homogeneous mixture.

The method may further include adding one or more stabilizers into the homogeneous mixture and homogenizing the homogeneous mixture.

The method may further include incorporating pigments and fillers into the homogeneous mixture and homogenizing the homogeneous mixture.

The method may further include extruding the homogeneous mixture into shape of the ring shaped disc of the gasket and/or drying.

The drying may be carried out at a temperature below about 150 degrees centigrade if the additive having the intumescing effect are contained in the permanent plastic putty of the gasket.

The following examples and comparison examples are provided to further illustrate exemplary embodiments of this invention.

### EXAMPLE 1

A putty is prepared from the following constituents,

| | | |
|---|---|---|
| Aqueous acrylate polymer dispersion | 15 | parts by weight |
| (water content of 37 percent, Acronal V271) | | |
| Liquid acrylate polymer (Acronal A4) | 20 | parts by weight |
| Water | 3 | parts by weight |
| Chalk (filler G) | 25 | parts by weight |
| Kaolin (filler G) | 14 | parts by weight |
| Expanding graphite (intumescing additives C3) | 16 | parts by weight |
| Ammonium polyphosphate (additive with | 6 | parts by weight |
| ceramizing activity C1) | | |
| Iron oxide (pigment F) | 0.4 | parts by weight |
| Fungicide (Mergal S97) | 0.3 | parts by weight |
| Dispersing agent (pigment dispersant E) | 0.3 | parts by weight |
| | 100 | parts by weight |

For preparing this putty, the acrylate dispersion, the fungicide, the dispersing agent and the water are added to a mixing vessel, the pH is adjusted to a value of 8 to 9 with ammonia, the liquid acrylate polymer is mixed in, the fillers, the pigment and the ammonium polyphosphate are incorporated and the mixture is homogenized. The expanding graphite is mixed in and the material is homogenized, the mixing and homogenizing being carried out in a planetary mixer.

Directly after it is mixed, the putty obtained has the consistency of a silicone sealing composition and a total water content of 8.55 percent.

This composition can be brought into the desired C-shaped disc form with suitable equipment (extruder and/or press) and dried at a temperature below 150 degrees centigrade to provide an embodiment of the gasket, the gasket material having the consistency of a sealing composition.

The viscosity of the putty, determined with the help of the DIN 515792 needle penetration test, is as follows: depth of penetration of the needle before drying: 18.6 mm; depth of penetration of the needle after drying: 4.6 mm.

### EXAMPLE 2

A putty, prepared by the procedure of Example 1 and containing a ceramizing, fire-protecting additive, is obtained using the following constituents:

| | | |
|---|---|---|
| Acrylate dispersion (Acronal V271) | 13.0 | percent by weight |
| Liquid polymer (Acronal A4) | 25.0 | percent by weight |
| Water | 2.0 | percent by weight |
| Stabilizers (fungicide, dispersant) | 0.6 | percent by weight |
| Pigment (iron oxide, titanium oxide) | 0.4 | percent by weight |
| Filler (chalk, kaolin 1:1) | 29.0 | percent by weight |
| Filler (powdered quartz) | 18.0 | percent by weight |
| Additive with ceramizing activity (zinc borate) | 6.0 | percent by weight |
| Additive with ceramizing activity (ammonium | 6.0 | percent by weight |
| polyphosphate) | | |

The produced putty has a water content of 6.8 percent by weight.

### EXAMPLE 3

A putty containing a fire-protection additive with a ceramizing activity and a fire-protection additive, having an ablative effect, is prepared according to the procedure of Example 1 using the following constituents:

| | | |
|---|---|---|
| Acrylate dispersion (Acronal V271) | 13.0 | percent by weight |
| Liquid polymer (Acronal A4) | 25.0 | percent by weight |
| Water | 2.0 | percent by weight |
| Stabilizers (fungicide, dispersant) | 0.6 | percent by weight |
| Pigment (iron oxide, titanium, oxide) | 0.4 | percent by weight |
| Filler (chalk, kaolin 1:1) | 20.0 | percent by weight |
| Additive with ceramizing activity | 6.0 | percent by weight |
| (zinc borate) | | |
| Additive with ablative activity | 33.0 | percent by weight |
| (aluminum hydroxide) | | |

The produced putty has a water content of 6.8 percent by weight.

### EXAMPLE 4

A putty, containing a chemically intumescing fire-protection additive, is produced using the procedure of Example 1 and the following constituents:

| | | |
|---|---|---|
| Acrylate dispersion (Acronal V271) | 13.0 | percent by weight |
| Liquid polymer (Acronal A4) | 25.0 | percent by weight |
| Water | 2.0 | percent by weight |
| Stabilizers (fungicide, dispersant) | 0.6 | percent by weight |
| Pigment (iron oxide, titanium oxide) | 0.4 | percent by weight |
| Filler (chalk, kaolin 1:1) | 23.0 | percent by weight |
| Filler (powdered quartz) | 10.0 | percent by weight |
| Chemically intumescing mixture (ammonium | 26.0 | percent by weight |
| polyphosphate + melamine + dipentaerythritol | | |
| 3:3:1) | | |

The produced putty has a water content of 6.8 percent by weight.

### EXAMPLE 5

For comparison of the surprising, intumescing effect achieved with the putty, a sealing composition, based on butyl rubber and containing a chemically intumescing fire-protection additive and such a sealing composition, into which 16 percent of expanding graphite has been incorporated, is compared with the putty of Example 1 with an expanding graphite content of 16 percent, with respect to the expansion behavior upon being heated to 600 degrees centigrade

The foam height was measured according to the guidelines for intumescing building materials of the DIBT, that is, after the test sample had being heated for 30 minutes at 600 degrees centigrade under a load of 5 g/cm².

It is evident that, with the sealing compound based on butyl rubber, which contains only a chemically intumescing fire-protection additive, no expansion whatsoever is achieved upon heating to 600 degrees centigrade. If this butyl rubber putty is treated with 16 percent by weight of expanding graphite, a foam height of only 11 mm is obtained, since the graphite is largely destroyed as it is being incorporated.

In contrast to the above, the putty used in an embodiment of the invention has a foam height of 45 mm, which corresponds to an expansion by a factor of 9.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gasket for sealing a gap between an external surface of a cylindrical structure and an inner surface of an opening, comprising:
a ring shaped disc of permanent plastic putty comprising a matrix composition and containing at least one fire-protection additive,
wherein the ring shaped disc is a C-shaped ring having a first end and a second end and a notch between the first end and the second end, wherein the ends seal against each other when the gap is sealed.

2. The gasket of claim 1, wherein the matrix composition comprises organic polymers including a mixture of an aqueous polymer dispersion and a low-molecular weight, permanently plastic, liquid polymer in a ratio by weight of the aqueous polymer dispersion to the low molecular weight, permanently plastic, liquid polymer of between about 6:1 and about 1:2.5.

3. The gasket of claim 2, comprising a fire protective sealing disc having first and second surfaces, wherein the fire-protection additive comprises one or more of any of the following: an additive with a ceramizing effect, an additive with an ablative effect, an additive with an intumescing effect, and an additive with a flame-inhibiting effect.

4. The gasket of claim 3, further comprising an elastic foil on the first surface of the fire protective sealing disc.

5. The gasket of claim 3, further comprising a release paper on the second surface of the fire protective sealing disc.

6. The gasket of claim 2, wherein the fire protective additive forms an ash crust when exposed to fire.

7. The gasket of claim 1, for sealing a gap between the external surface of the cylindrical structure and the inner surface of an opening in a drywall.

8. The gasket of claim 1, wherein the cylindrical structure is selected from a wire, a cable, a cable bundle, and a pipe.

9. The gasket of claim 4, further comprising a release paper on the second surface of the fire protective sealing disc.

10. The gasket of claim 1, comprising a fire protective sealing disc having first and second surfaces, wherein the fire-protection additive comprises one or more of any of the following: an additive with a ceramizing effect, an additive with an ablative effort, an additive with an intumescing effect, and an additive with a flame-inhibiting effect.

11. The gasket of claim 1, wherein the fire protective additive forms an ash crust when exposed to fire.

12. The gasket of claim 10, wherein the fire protective additive forms an ash crust when exposed to fire.

13. The gasket of claim 10, further comprising an elastic foil on the first surface of the fire protective sealing disc.

14. The gasket of claim 10, further comprising a release paper on the second surface of the fire protective sealing disc.

15. The gasket of claim 13, further comprising a release paper on the second surface of the fire protective sealing disc.
